(19) United States
(12) Patent Application Publication
(10) Pub. No.: US 2020/0098233 A1
(43) Pub. Date: Mar. 26, 2020

(54) PORTABLE ELECTRONIC DEVICE FOR PROVIDING ENVIRONMENTAL AWARENESS TO A USER

(71) Applicant: KLee Terrazas, Edmond, OK (US)

(72) Inventor: KLee Terrazas, Edmond, OK (US)

(21) Appl. No.: 16/138,550

(22) Filed: Sep. 21, 2018

(51) Int. Cl. G08B 17/10; H04N 7/18; G06F 3/0488; G08B 5/22; G08B 3/10; G08B 6/00

(52) U.S. Cl. CPC G08B 17/10; H04N 7/183; G08B 6/00; G08B 5/223; G08B 3/1016; G06F 3/04883

(57) ABSTRACT

Disclosed is a portable electronic device for providing environmental awareness to a user. The portable electronic device may include a communication device configured for receiving environmental data from at least one sensor device. Further, the portable electronic device may include a storage device configured for storing at least one predetermined signature corresponding to at least one environmental data. Further, the portable electronic device may include a processing device communicatively coupled to each of the storage device and the communication device. Further, the processing device may be configured for analyzing the environmental data, for determining at least one environmental data signature based on the analyzing, for comparing the at least one environmental data signature with the at least one predetermined signature, and generating at least one alert based on the comparing. Further, the portable electronic device may include a presentation device communicatively coupled to the processing device.

### FIELD OF THE INVENTION

The present disclosure relates generally to the field of electronic devices. More specifically, the present disclosure relates to electronic devices to assist users with disabilities.

### BACKGROUND OF THE INVENTION

Most parents find it hard to raise children. Apart from taking care of the basic requirements, parents are very concerned about the safety of their children. This is even more challenging if a parent has hearing impairment as they may be unable to respond correctly to their children. For example, they may not be able to help their child, if the child needs help at night or when the parent is busy in another room. Further, a child may fall from height such as a kitchen slab and they may not hear them falling or their cries for help. For older children, the parents may be concerned about them sneaking out unheard at odd hours.

Further, people suffering from hearing impairment find it challenging to reach their potential as they are unable to communicate effectively with other people. Further, often they are unable to drive vehicles.

Therefore, there is a need for improved devices that may assist people suffering from hearing impairment that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a portable electronic device for providing environmental awareness to a user is disclosed. The portable electronic device may include a communication device configured for receiving environmental data from at least one sensor device. Further, the receiving of the environmental data may be performed over a short-range wireless communication channel (e.g. Bluetooth, NFC, Wi-Fi, Smart Home' Technology, Z-Wave, Zigbee, etc.). Further, the portable electronic device may include a storage device configured for storing at least one predetermined signature corresponding to at least one environmental data. Further, the portable electronic device may include a processing device communicatively coupled to each of the storage device and the communication device. Further, the processing device may be configured for analyzing the environmental data. Further, the processing device may be configured for determining at least one environmental data signature based on the analyzing. Further, the processing device may be configured for comparing the at least one environmental data signature with the at least one predetermined signature. Further, the processing device may be configured for generating at least one alert based on the comparing. Further, the portable electronic device may include a presentation device communicatively coupled to the processing device. Further, the presentation device may be configured for presenting the at least one alert. Further, the presentation device may include one or more of a display device and a tactile device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a portable electronic device for providing environmental awareness to a user, in accordance with some embodiments.

FIG. 3 is a block diagram of the portable electronic device for providing environmental awareness to a user, in accordance with further embodiments.

FIG. 4 is a block diagram of the portable electronic device for providing environmental awareness to a user, in accordance with further embodiments.

FIG. 5 is a block diagram of the portable electronic device for providing environmental awareness to a user, in accordance with further embodiments.

FIG. 6 is a block diagram of the portable electronic device for providing environmental awareness to a user, in accordance with further embodiments.

FIG. 7 is a block diagram of a portable electronic device for providing environmental awareness to a user, in accordance with some embodiments.

FIG. 8 is a block diagram of the portable electronic device for providing environmental awareness to a user, in accordance with further embodiments.

FIG. 9 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.” The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of spreading environmental awareness, embodiments of the present disclosure are not limited to use only in this context.

Overview

According to some embodiments, the present disclosure relates to an in-home audio/video system (called Hearts-To-Hear system), a downloadable application (called Hearts-To-Hear application) installed on one or more specialized electronic devices (called Hearts-To-Hear devices) that may be used the hearing impairment people. For example, the Hearts-To-Hear devices include one or more of a tablet, smartwatch, a tablet or in-car microphones.

Further, the Hearts-To-Hear application may be purchased from an application store. The Hearts-To-Hear application may be compatible with various smart devices that aid the hearing impaired people by giving them independence. The Hearts-To-Hear application may translate voice message of a non-hearing impaired party into text and allow the hearing impaired to type a message in response that may be then read aloud to the non-hearing impaired party. Further, the Hearts-To-Hear system may connect an in-home security/automation system to the other smart devices via the Hearts-To-Hear application. This may be used to alert a hearing impaired person to situations, such as fire alarms, loud breaking noises, screaming or crying from other rooms, windows or doors opening, and so. The Hearts-To-Hear application may be installed on computers, tablets, smartwatches, any other smart devices that include an external microphone, which may be used to cancel noises, when the hearing impaired person is speaking to someone.

According to some embodiments, the present disclosure relates to an alerting system and a portable hearing system for the hearing impaired, deaf, or hard of hearing people. The alerting system may include one or more of, but is not limited to, in-home automation system, a smart television set, a smartwatch, a tablet, a computer, a cell phone along with other smart linking devices, such as a doorbell, window security devices, and so on. The alerting system may be configured to detect a number of preset sounds, as well as any sound programed by the user. Further, the alerting system may send an alert via vibration and video feed to any devices connected to the home automation system, thereby alarming the deaf, hearing impaired, or hard of hearing person to a number of safety alarms with a video feed to allow them to assess or dismiss the alarm.

Further, the alerting system may include an in-home smart system with an application that may connect the smart devices in the home to send alerts, messages, or alarms to one or more connected devices.

Further, the alerting system may transmit alarms, alerts, or messages to alert the user using at least one device to transmit the message directly to a selected device(s).

Further, the alerting system may use video feed received from the connected smart devices, microphones, and the home automation system to transmit messages to the user using the video feed as well as text to the selected devices.

Further, the alerting system may allow the user to download the Hearts-To-Hear application to portable devices such as a car system, a smartwatch, a cell phone, and other smart devices with a microphone preset to the programed alarms.

Further, the alerting system may allow the user to see the written text when others are talking to the user. Further, it provides the ability to type responses to be read aloud to the non-hearing-impaired people. Thus, giving them freedom from the need for a translator in public settings allowing the user to communicate with other people easily.

Further, a portable microphone may be placed on the inside and outside of the user's car to give them alerts outside the home with video feed where applicable to convey warnings, alarms, alerts, and other programed settings such as (but not limited to) a car horn, weather alarms, sirens, loud sudden noses, baby crying, and so forth. These warnings/alarms may be conveyed through the vibration of devices such as a smartwatch, or cell phone. Further, the alerting system may allow users to edit and/or add to programmable alerts. The disclosed alerting system provides more independence, safety, connect-ability to users with hearing impairment.

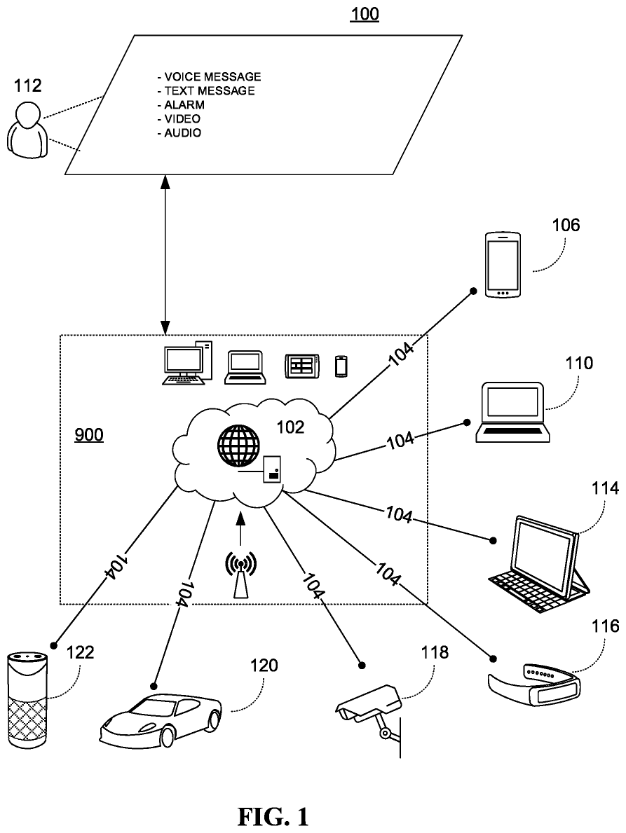

Referring now to figures, FIG. 1 is an illustration of an online platform 100 consistent with various embodiments of the present disclosure. By way of non-limiting example, the online platform 100 for providing environmental awareness to a user may be hosted on a centralized server 102, such as, for example, a cloud computing service. The centralized server 102 may communicate with other network entities, such as, for example, a mobile device 106 (such as a smartphone), other computing devices 110 (such as desktop computers, server computers, laptops etc.), a tablet 114, a smartwatch 116, a surveillance camera 118, a car 120, a home automation device 122, over a communication network 104, such as, but not limited to, the Internet. Further, users of the online platform 100 may include relevant parties such as, but not limited to, children, caregivers, parents, guardians, teachers and administrators. Accordingly, in some instances, electronic devices operated by the one or more relevant parties may be in communication with the platform 100.

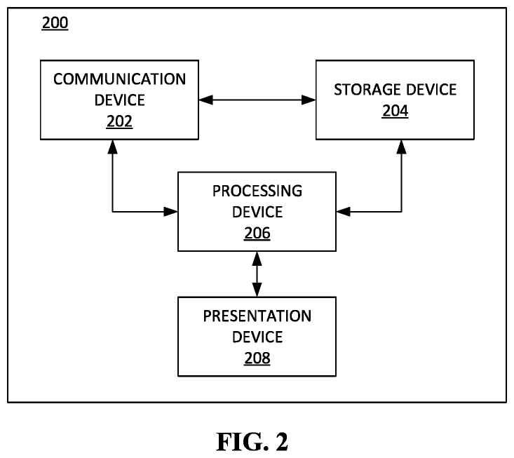

A user 112, such as the one or more relevant parties, may access online platform 100 through a web-based software application or browser. The web-based software application may be embodied as, for example, but not be limited to, a website, a web application, a desktop application, and a mobile application compatible with a computing device 900. The platform 100 may be configured to communicate with a portable electronic device 200 for providing environmental awareness to a user, such as the user 112. The portable electronic device 200 is explained in detail in conjunction with FIG. 2 below.

The tablet 114 may be a specialized tablet called Hearts-To-Hear Talking tablet. For example, a deaf user may use the tablet 114 for conversing with another person. The tablet 114 may allow the deaf user to quickly type their response and let it be read out loud to the other person in the conversation. Further, the tablet 114 may include a built-in microphone that may listen and type-out the other person's response. Further, the tablet 114 may store many pre-typed messages for the deaf user to quickly pull from. Further, the tablet 114 may include a built-in tracking device. Further, the tablet 114 may use Bluetooth™ connections to link to other specialized devices, called Hearts-To-Hear devices. In loud areas, a retractable microphone (from the tablet 114) may be handed to the other person, such that the microphone only picks up the other person's voice for translation. Accordingly, the tablet 114 may assist people with hearing impairment to communicate with caregivers, teachers, friends or family without the presence of a translator.

The smartwatch 116 may be a specialized smartwatch called Hearts-To-Hear smartwatch. The smartwatch 116 may include technology to receive video feed from other linked devices. Further, the smartwatch 116 may trigger vibration alarms, such as when a fire alarm is triggered, a door bell is rung, a baby's crying sound is detected, a yelling or scream sound is detected, a door opening or closing is detected etc. The smartwatch 116 may be set to vibrate more intensely during the night as to awake the user in the case an alarm is triggered. Further, the smartwatch 116 has a built-in microphone. Further, the smartwatch 116 may connect to other compatible devices within range.

The surveillance camera 118 may be a specialized surveillance camera called Hearts-To-Hear in-home security camera. The surveillance camera 118 may include a microphone. The surveillance camera 118 may allow parents view a live video from all rooms using the mobile device 106, the smartwatch 116 or the tablet 114.

The car 120 may include an external car microphone and in-car application, called Hearts-to-Hear application. The in-car application may alarm the driver via vibration and/or video feed where applicable based on preprogrammed alerts. The in-car application may allow the user to add or edit alerts. Further, the in-car application may provide directions (based on GPS) on a video screen in the car 120. Further, the in-car application may alarm the driver, when the external car microphone picks up sound of a horn of another vehicle nearby. Thereby, the in-car application may allow a deaf driver to drive vehicles safely on roads.

The home automation device 122 may be a specialized home automation device called Hearts-To-Hear in-home security automation. The home automation device 122 may include camera and built-in microphones. The home automation device 122 may automatically connect to any compatible devices nearby. The home automation device 122 may operate with a home security system. Accordingly, if the home automation device 122 detects opening of doors or windows, then an alarm may be triggered via a vibration on the mobile device 106 and/or smartwatch 116.

A user may use any device from the mobile device 106, the other computing devices 110, the tablet 114, the smartwatch 116, the surveillance camera 118, the car 120 (in-car application), the home automation device 122 for conversing with other people nearby. The user may type their message in the selected device, which will then convert the typed message into a voice message and play it to the other people involved in the conversation. For example, a voice command “call mom” may notify a hearing impaired mom alerting her that her child at home needs her help. The alert may be a voice “text” to the mobile device 106, the tablet 114, or the smartwatch 116 of the user along with the vibration alert.

FIG. 2 is a block diagram of the portable electronic device 200 for providing environmental awareness to a user, in accordance with some embodiments. The portable electronic device 200 may include a communication device 202 configured for receiving environmental data from at least one sensor device. Further, the receiving of the environmental data may be performed over a short-range wireless communication channel. Alternatively, in some embodiments, the receiving of the environmental data may be performed over a Wi-Fi communication channel. Other examples of the communication channel may include, but are not limited to, Bluetooth, NFC, Smart Home' Technology, Z-Wave, Zigbee, etc. Further, the portable electronic device 200 may include a storage device 204 configured for storing at least one predetermined signature corresponding to at least one environmental data. Further, the portable electronic device 200 may include a processing device 206 communicatively coupled to each of the storage device 204 and the communication device 202. Further, the processing device 206 may be configured for analyzing the environmental data. Further, the processing device 206 may be configured for determining at least one environmental data signature based on the analyzing. Further, the processing device 206 may be configured for comparing the at least one environmental data signature with the at least one predetermined signature. Further, the processing device 206 may be configured for generating at least one alert based on the comparing. Further, the portable electronic device 200 may include a presentation device 208 communicatively coupled to the processing device 206. Further, the presentation device 208 may be configured for presenting the at least one alert. Further, the presentation device 208 may include one or more of a display device and a tactile device.

In some embodiments, the communication device 202 may be further configured for scanning a plurality of wireless signals corresponding to a plurality of wireless devices; identifying the at least one sensor device based on the scanning. Further, the communication device 202 may be configured for establishing the short-range wireless communication channel based on the identifying. In an instance, the short-range communication channel may be a Wi-Fi communication channel.

In some embodiments, the communication device 202 may be further configured for transmitting an authentication token to the at least one sensor device. Further, the communication device 202 may be configured for receiving an authentication response from the at least one sensor device. Further, the establishing may be based on receiving the authentication response. For example, the at least one sensor device may be a device in a home/office environment. Accordingly, a connection may be established between the portable electronic device 200 and the device in the home/office environment based on authentication. Accordingly, only devices belonging to authorized users may be able to automatically connect with the devices at home/office.

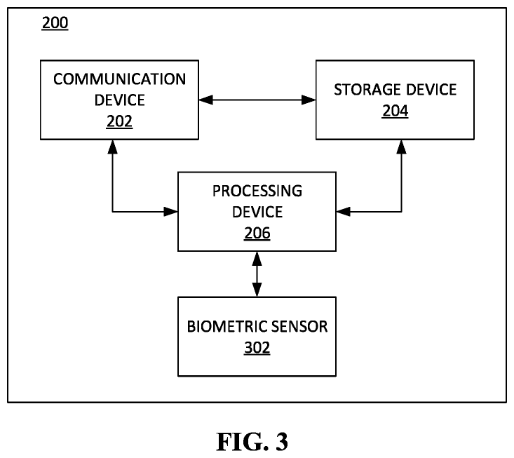

FIG. 3 is a block diagram of the portable electronic device 200 for providing environmental awareness to a user, in accordance with further embodiments. The portable electronic device 200 may further include a biometric sensor 302 configured to detect at least one biometric variable associated with the user. Accordingly, the authentication token may be based on the biometric variable.

In some embodiments, the communication device 202 may be further configured for transmitting a policy request to the at least one sensor device. Further, the communication device 202 may be configured for receiving a privacy policy from the at least one sensor device. Further, the processing device 206 may be further configured for analyzing the privacy policy. Further, the establishing may be further based on the analyzing of the privacy policy. For example, the at least one sensor device (such as a surveillance camera) may be temporarily and/or permanently designated as private based on a privacy policy, according to which the portable electronic device 200 may not receive any video feeds from the sensor device.

In some embodiments, the at least one sensor device may include one or more of a smart-home appliance, a smoke detector, and a gas detector.

In some embodiments, the at least one sensor device may include an opening detector configured for detecting a state of an opening. For example, the opening may be one or more of a door and a window.

In some embodiments, the at least one sensor device may include a surveillance device including an image capturing unit configured for capturing an image and a sound capturing unit configured for capturing a sound. Further, the environmental data may include the image and the sound.

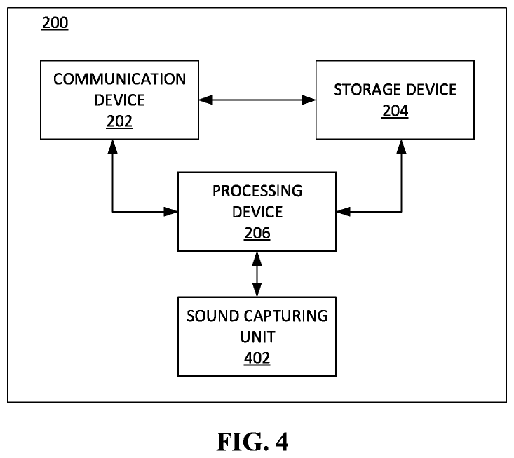

FIG. 4 is a block diagram of the portable electronic device 200 for providing environmental awareness to a user, in accordance with further embodiments. The portable electronic device 200 may further include a sound capturing unit 402 communicatively coupled to the processing device 206. Further, the processing device 206 may be configured for analyzing the sound. Further, the processing device 206 may be configured for determining at least one sound signature based on the analyzing of the sound. Further, the processing device 206 may be configured for comparing the at least one sound signature with the at least one predetermined sound signature. Further, the storage device 204 may be further configured for storing the predetermined sound signature. Further, generating of the at least one alert may be further based on the comparing of the at least one sound signature with the at least one predetermined sound signature.

In some embodiments, the processing device 206 may be further configured for generating a visual message based on the analyzing of the environmental data. Further, the display device may be configured for displaying the visual message.

In some embodiments, the visual message may include a textual message.

In some embodiments, the display device may include a touchscreen configured to receive a touch input including a response message. Further, the communication device 202 may be further configured for transmitting the response message to the at least one sensor device.

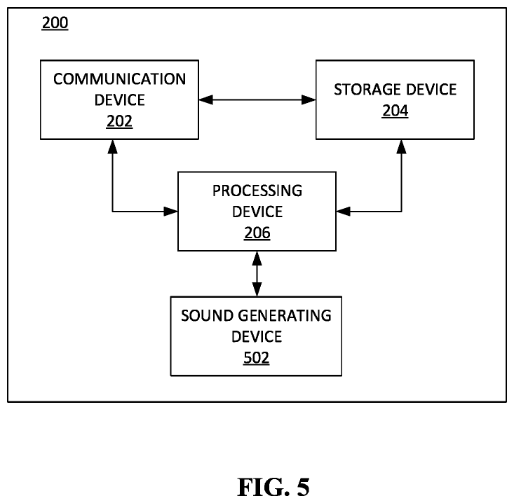

FIG. 5 is a block diagram of the portable electronic device 200 for providing environmental awareness to a user, in accordance with further embodiments. The portable electronic device 200 may further include a sound generating device 502 communicatively coupled to the processing device 206. Further, the sound generating device 502 may be configured for generating audible sounds based on the response message.

In some embodiments, the at least one sensor device may be comprised in a vehicle.

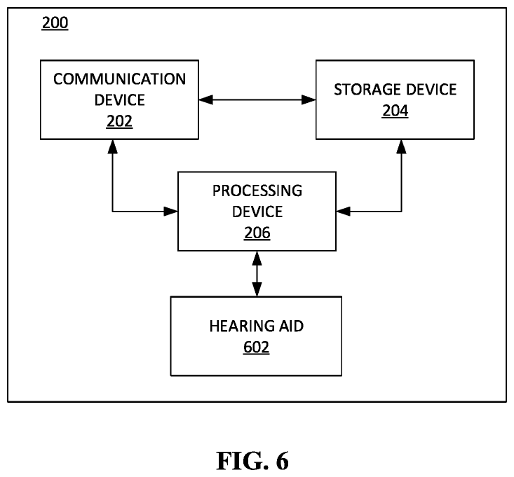

FIG. 6 is a block diagram of the portable electronic device 200 for providing environmental awareness to a user, in accordance with further embodiments. The portable electronic device 200 may further include a hearing aid 602 configured for enhancing the hearing ability of the user.

In some embodiments, the communication device 202 may be further configured for transmitting the at least one alert to an external indicating device configured for providing one or more of a visual indication and a tactile indication based on the at least one alert. Accordingly, in some embodiments, external indication devices such as light emitters and/or vibration mats may be placed in places where the user is likely to be present (e.g. on walls, under mats/carpets, under a mattress, under a chair, etc.). Accordingly, in a scenario where the user's attention is not directed towards the display device of the portable electronic device 200 and/or the portable electronic device 200 is not in physical contact with the user, the user may still be made aware of the at least one alert.

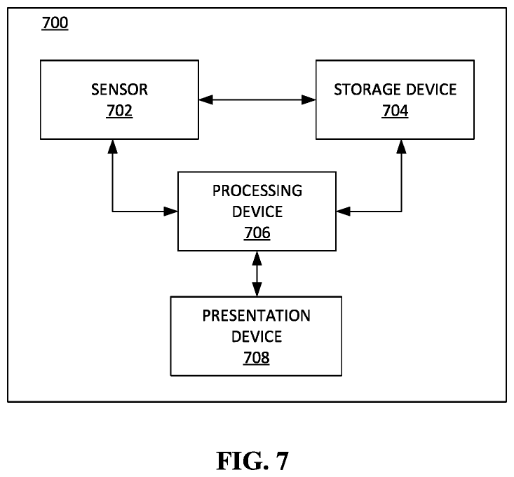

FIG. 7 is a block diagram of a portable electronic device 700 for providing environmental awareness to a user, in accordance with some embodiments. The portable electronic device 700 including at least one sensor 702 configured for sensing environmental data. Further, the portable electronic device 700 may include a storage device 704 configured for storing at least one predetermined signature corresponding to at least one environmental data. Further, the portable electronic device 700 may include a processing device 706 communicatively coupled to the storage device 204. Further, the processing device 706 may be configured for analyzing the environmental data. Further, the processing device 706 may be configured for determining at least one environmental data signature based on the analyzing. Further, the processing device 706 may be configured for comparing the at least one environmental data signature with the at least one predetermined signature. Further, the processing device 706 may be configured for generating at least one alert based on the comparing. Further, the portable electronic device 700 may include a presentation device 708 communicatively coupled to the processing device 206. Further, the presentation device 708 may be configured for presenting the at least one alert. Further, the presentation device 708 may include of one or more of a display device and a tactile device.

For example, the portable electronic device 700 may be used outdoors (e.g. within a car) to detect external sounds (e.g. horn sound from other cars, emergency sirens. ambulance/firetruck sirens etc.) and accordingly identify the type of sound and alert the user (e.g. hearing impaired user) using a visual message and/or tactile signal (e.g. vibration).

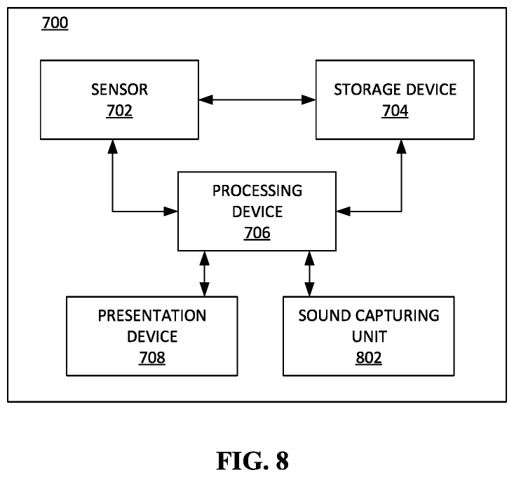

FIG. 8 is a block diagram of the portable electronic device 700 for providing environmental awareness to a user, in accordance with further embodiments. The portable electronic device 700 further including a sound capturing unit 802 communicatively coupled to the processing device 706. Further, the sound capturing unit 802 may be configured for capturing a speech sound. Further, the processing device 706 may be further configured for analyzing the speech sound and generating the at least one predetermined signature based on the analyzing of the speech sound.

Accordingly, the portable electronic device 700 may enable the user to specify the condition corresponding to which an alert is to be generated. For example, the user may provide a speech input such as “alert me when the porch door is opened after 7 pm”. The portable electronic device 700 may then generate an alarm whenever the porch door is opened after 7 PM.

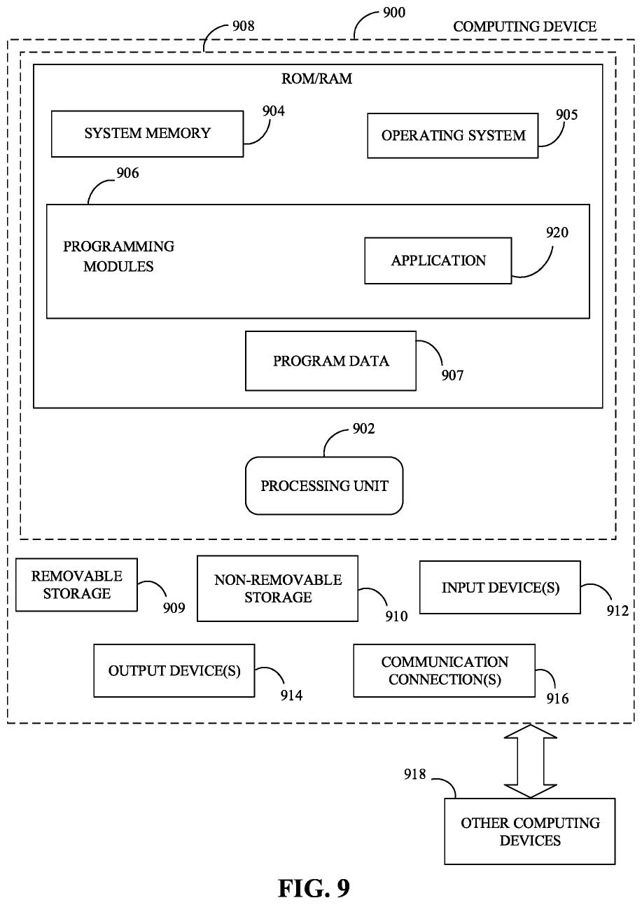

With reference to FIG. 9, a system consistent with an embodiment of the disclosure may include a computing device or cloud service, such as computing device 900. In a basic configuration, computing device 900 may include at least one processing unit 902 and a system memory 904. Depending on the configuration and type of computing device, system memory 904 may comprise, but is not limited to, volatile (e.g. random-access memory (RAM)), non-volatile (e.g. read-only memory (ROM)), flash memory, or any combination. System memory 904 may include operating system 905, one or more programming modules 906, and may include a program data 907. Operating system 905, for example, may be suitable for controlling computing device 900's operation. In one embodiment, programming modules 906 may include machine learning module. Furthermore, embodiments of the disclosure may be practiced in conjunction with a graphics library, other operating systems, or any other application program and is not limited to any particular application or system. This basic configuration is illustrated in FIG. 9 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910. Computer storage media may include volatile and nonvolatile, removable and non-removable media implemented in any method or technology for storage of information, such as computer-readable instructions, data structures, program modules, or other data. System memory 904, removable storage 909, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a touch input device, a location sensor, a camera, a biometric sensor, etc. Output device(s) 914 such as a display, speakers, a printer, etc. may also be included. The aforementioned devices are examples and others may be used.

Computing device 900 may also contain a communication connection 916 that may allow device 900 to communicate with other computing devices 918, such as over a network in a distributed computing environment, for example, an intranet or the Internet. Communication connection 916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 904, including operating system 905. While executing on processing unit 902, programming modules 906 (e.g., application 920 such as a media player) may perform processes including, for example, one or more stages of methods, algorithms, systems, applications, servers, databases as described above. The aforementioned process is an example, and processing unit 902 may perform other processes. Other programming modules that may be used in accordance with embodiments of the present disclosure may include data processing application, machine learning application, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the disclosure has been explained in relation to its preferred embodiment, it is to be understood that many other possible modifications and variations can be made without departing from the spirit and scope of the disclosure.

We claim:

1. A portable electronic device for providing environmental awareness to a user, the portable electronic device comprising:
a communication device configured for receiving environmental data from at least one sensor device, wherein the receiving of the environmental data is performed over a short-range wireless communication channel;
a storage device configured for storing at least one predetermined signature corresponding to at least one environmental data;
a processing device communicatively coupled to each of the storage device and the communication device, wherein the processing device is configured for:
analyzing the environmental data;
determining at least one environmental data signature based on the analyzing;
comparing the at least one environmental data signature with the at least one predetermined signature; and
generating at least one alert based on the comparing;
a presentation device communicatively coupled to the processing device, wherein the presentation device is configured for presenting the at least one alert, wherein the presentation device comprises of at least one of a display device and a tactile device.

2. The portable electronic device of claim 1, wherein the communication device is further configured for:
scanning a plurality of wireless signals corresponding to a plurality of wireless devices;
identifying the at least one sensor device based on the scanning; and
establishing the short-range wireless communication channel based on the identifying.

3. The portable electronic device of claim 2, wherein the communication device is further configured for:
transmitting an authentication token to the at least one sensor device; and
receiving an authentication response from the at least one sensor device, wherein the establishing is based on receiving the authentication response.

4. The portable electronic device of claim 4 further comprising a biometric sensor configured to detect at least one biometric variable associated with the user, wherein the authentication token is based on the biometric variable.

5. The portable electronic device of claim 2, wherein the communication device is further configured for:
transmitting a policy request to the at least one sensor device; and
receiving a privacy policy from the at least one sensor device, wherein the processing device is further configured for analyzing the privacy policy, wherein the establishing is further based on the analyzing of the privacy policy.

6. The portable electronic device of claim 1, wherein the at least one sensor device comprises a smart-home appliance.

7. The portable electronic device of claim 1, wherein the at least one sensor device comprises a smoke detector.

8. The portable electronic device of claim 1, wherein the at least one sensor device comprises a gas detector.

9. The portable electronic device of claim 1, wherein the at least one sensor device comprises an opening detector configured for detecting a state of an opening.

10. The portable electronic device of claim 1, wherein the at least one sensor device comprises a surveillance device comprising of an image capturing unit configured for capturing an image and a sound capturing unit configured for capturing a sound, wherein the environmental data comprises the image and the sound.

11. The portable electronic device of claim 1 further comprising a sound capturing unit communicatively coupled to the processing device, wherein the processing device is configured for:
analyzing the sound;
determining at least one sound signature based on the analyzing of the sound; and
comparing the at least one sound signature with the at least one predetermined sound signature, wherein the storage device is further configured for storing the predetermined sound signature, wherein generating of the at least one alert is further based on the comparing of the at least one sound signature with the at least one predetermined sound signature.

12. The portable electronic device of claim 1, wherein the processing device is further configured for generating a visual message based on the analyzing of the environmental data, wherein the display device is configured for displaying the visual message.

13. The portable electronic device of claim 12, wherein the visual message comprises a textual message.

14. The portable electronic device of claim 12, wherein the display device comprises a touchscreen configured to receive a touch input comprising a response message, wherein the communication device is further configured for transmitting the response message to the at least one sensor device.

15. The portable electronic device of claim 14 further comprising a sound generating device communicatively coupled to the processing device, wherein the sound generating device is configured for generating audible sounds based on the response message.

16. The portable electronic device of claim 1, wherein the at least one sensor device is comprised in a vehicle.

17. The portable electronic device of claim 1 further comprising a hearing aid configured for enhancing the hearing ability of the user.

18. The portable electronic device of claim 1, wherein the communication device is further configured for transmitting the at least one alert to an external indicating device configured for providing at least one of a visual indication and a tactile indication based on the at least one alert.

19. A portable electronic device for providing environmental awareness to a user, the portable electronic device comprising:
at least one sensor configured for sensing environmental data;
a storage device configured for storing at least one predetermined signature corresponding to at least one environmental data;
a processing device communicatively coupled to the storage device, wherein the processing device is configured for:
analyzing the environmental data;
determining at least one environmental data signature based on the analyzing;
comparing the at least one environmental data signature with the at least one predetermined signature; and
generating at least one alert based on the comparing;
a presentation device communicatively coupled to the processing device, wherein the presentation device is configured for presenting the at least one alert, wherein the presentation device comprises of at least one of a display device and a tactile device.

20. The portable electronic device further comprising a sound capturing unit communicatively coupled to the processing device, wherein the sound capturing unit is configured for capturing a speech sound, wherein the processing device is further configured for:
analyzing the speech sound; and
generating the at least one predetermined signature based on the analyzing of the speech sound.
